(19) United States
(12) Patent Application Publication
(10) Pub. No.: US 2004/0177539 A1
(43) Pub. Date: Sep. 16, 2004

(54) Universal sign lamp system using color coded symbols

(76) Inventor: Chang Soo Kim, Garden Grove, CA (US)

Correspondence Address: PARK & SUTTON LLP, 3255 WILSHIRE BLVD, SUITE 1110, LOS ANGELES, CA, 90010, US

(21) Appl. No.: 10/798,493

(22) Filed: Mar. 11, 2004

Related U.S. Application Data
(60) Provisional application No. 60/454,157, filed on Mar. 12, 2003.
(60) Provisional application No. 60/455,540, filed on Mar. 18, 2003.
(60) Provisional application No. 60/454,156, filed on Mar. 12, 2003.

(51) Int. Cl. G09F 13/04

(52) U.S. Cl. 40/575

(57) ABSTRACT

A color coded sign system comprises a base frame mounted on a wall or a ceiling, and a plurality of replacement panels each having at least one opening. A selected one of the replacement panels is detachably hooked in hook rails of the base frame and the opening is covered by a colored member.

### CROSS REFERENCES RELATED TO THIS APPLICATION

The applicant claims the benefits and priorities of the U.S. provisional application Nos. 60/454/157 filed on Mar. 12, 2003; 60/455,540 filed on Mar. 18, 2003; and 60/454,156 filed on Mar. 12, 2003.

### BACKGROUND OF INVENTION

The present invention relates to a sign lamp. More particularly, the present invention relates to an improved universal sign lamp system using color coded symbols and effectively coordinating with blinking and flashing characteristics of light bulbs.

Symbols are known to better deliver message over letters that require understanding of a language. A variety of signs are presently being used for the convenience's sake in almost all nations on the globe. Further, an increasing number of signs are in use inside business buildings together with letters. For example, a lady's room is expressed by a combination of letters and symbols that show a lady in a simplified drawing format.

For an individual to recognize symbols and letters in an unfamiliar environment and to take an action in a convinced manner is substantially affected by cultural backgrounds and mother languages to which one has been mostly exposed. In this sense, the conventional symbols and letters have limitations in terms of universal consensus.

The applicant believes that a color coding system using universally recognized colors would optimally supplement drawbacks of the conventional sign systems.

### SUMMARY OF THE INVENTION

The present invention is contrived to overcome conventional disadvantages. Accordingly, it is an object of the present invention is to provide a color coded sign system effectively coordinating with blinking and flashing characteristics of light bulbs. Another object is to provide a universal standard form for the sign system.

To achieve these and other objects, the color coded sign system comprises a base frame mounted on a wall or a ceiling, and a plurality of replacement panels each having at least one opening where a selected one of the replacement panels is detachably hooked in hook rails of the base frame. The opening is covered by a colored member. The colored member selectively adopts blue, red, green, purple, brown and orange, wherein the blue, red, green, purple, brown and orange colored members sequentially signify a man's restroom sign, a lady's restroom sign, an exit/entrance sign, an elevator sign, a stairways sign and a no exit/entrance sign.

In a preferred version, the color coded sign system comprises a base frame mounted on a wall or a ceiling, a circuit board having at least one electric port with the circuit board installed in the base frame and connected to a controller, a light bulb having a bulb base detachably mounted in the port where the light bulb is blinkable under control of the controller, and a plurality of replacement panels each having at least one opening. A selected one of the replacement panels is detachably hooked in hook rails of the base frame, and the opening is covered by a colored member.

In an embodiment, the color coded sign system is provided with a plurality of light bulbs each having a bulb base, and the flashing member incorporated in the circuit board to control bulb blinking sequences and intervals. The flashing member may be removably provided between the bulb base and the port in form of a bulb flasher. The colored member may be either an acrylic plate or a glass. Preferably, the acrylic plate or the glass is colored by one selected from blue, red, green, purple, brown, and orange. So the blue, red, green, purple, brown and orange acrylic plates or glasses sequentially signify a man's restroom sign, a lady's restroom sign, an exit/entrance sign, an elevator sign, a stairways sign and a no exit/entrance sign. The acrylic plate or the glass is two-tone colored by blue and red to signify a bisexual common restroom. In a preferred mode, each replacement panel is substantially prismatic in shape.

An advantage of the present invention is that the color coded symbols provided in combination of colored plates and non-colored lamp or of colored plates and blinking and/or flashing substantially improve recognition rate compared to the conventional symbols, thereby enhancing usability and applicability. In addition, the interchangeability of the replacement panels allows flexibility and saves cost, thereby enhancing user satisfaction while decreasing maintenance cost. Further, the color allocation coded with ergonomic senses minimizes error ratio in finding the wanted spot, thereby maximizing product reliability.

Although the present invention is briefly summarized, the fuller understanding of the invention can be obtained by the following drawings, detailed description and appended claims.

### BRIEF DESCRIPTION OF THE DRAWINGS

The above objects and advantages will be more apparent by describing the present invention with reference to the accompanying reference drawings, in which:

FIG. 1 is a view showing a color coded sign system according to the present invention;

FIG. 2 is a partially exploded view showing construction of the present invention;

FIG. 3 is a perspective view showing another embodiment of the present invention;

FIG. 4 is a view showing still another embodiment of the present invention; and

FIG. 5 is a flowchart showing operation mechanism of the present invention.

### DETAILED DESCRIPTION OF THE PREFERRED EMBODIMENTS

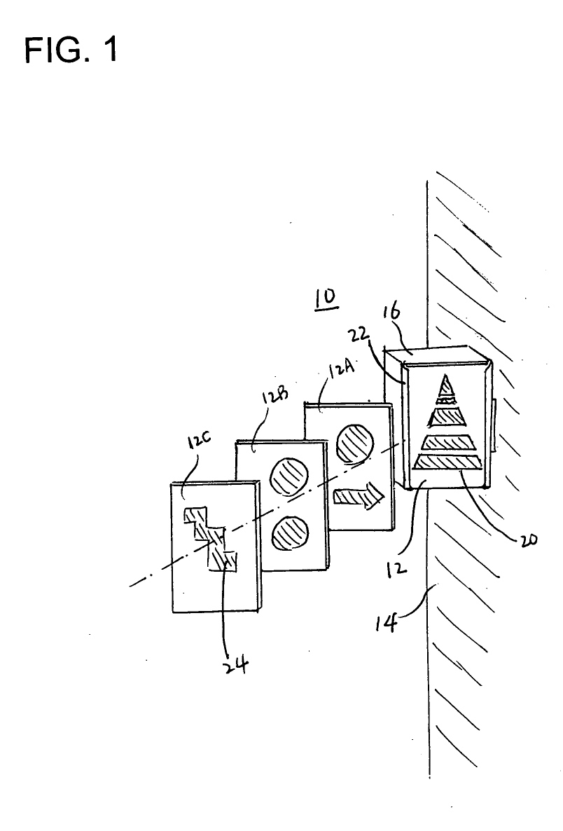

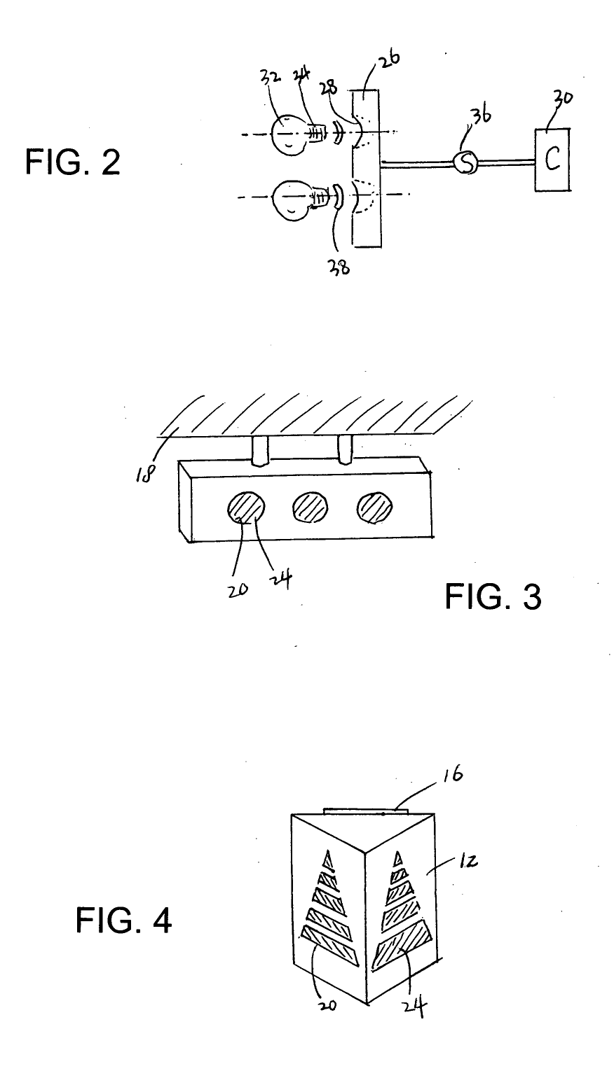

FIG. 1 shows a color coded sign system 10 with a present panel 12 and a plurality of other replacement panels 12A, 12B, 12C where the sign system 10 is attached to a wall 14. FIG. 2 shows a construction of the sign system 10 to demonstrate its functional mechanism. As shown therein, The color coded sign system 10 is mountable on a wall inside a building to provide easy-to-find indications and directions, for example, for an elevator, a stairway, a telephone booth, restrooms and other public spots frequented by those visiting or working in a building.

In an embodiment, the color coded sign system 10 comprises a base frame 16 mounted on a wall 14 or a ceiling 18 as shown in FIG. 3. A plurality of replacement panels 12 and 12A-12C are provided to each have at least one opening 20. In a preferred mode, the panel 12 selected from the replacement panels is detachably hooked in hook rails 22 of the base frame 16 and the opening 20 is covered by a colored member 24. That is, each opening 20 is attachedly covered by the colored member 24. The colored member 24 is preferably formed of an acrylic plate or a glass, which is colored by one selected from blue, red, green, purple, brown, and orange.

That is, the colored member 24 selectively adopts blue, red, green, purple, brown and orange, so that the blue, red, green, purple, brown and orange colored members sequentially signify a man's restroom sign, a lady's restroom sign, an exit/entrance sign, an elevator sign, a stairways sign and a no exit/entrance sign.

For a better performance, the color coded sign system 10 includes the base frame 16 mounted on a wall 14 or a ceiling 18. A circuit board 26 having at least one electric port 28 is installed in the base frame 16 and connected to a controller 30. At least one light bulb 32 having a bulb base 34 is detachably mounted in the corresponding port 28. The light bulb 32 is blinkable under control of the controller 30. Between the circuit board 26 and the controller 30 is preferably provided a switch 36 for safety purposes. The plurality of replacement panels 12 and 12A-12C are provided to each have at least one opening 20 shaped in correspondence to the user's preferences.

Selectively, a flashing member 38 is incorporated in the circuit board 26 to control bulb blinking sequences and intervals. It is also preferred that the flashing member 38 is removably provided between each bulb base 34 and the corresponding port 28. In a preferred mode, the flashing member 38 is a bulb flash or selected from other types of flashers including flashing LED to better control the blinking and/or flashing characteristics in cooperation with the controller 30.

The colored member 24 formed of acrylic plates or glasses preferably adopt the colors of blue, red, green, purple, brown and orange to sequentially signify a man's restroom sign, a lady's restroom sign, an exit/entrance sign, an elevator sign, a stairways sign and a no exit/entrance sign.

To improve product usability, the acrylic plates or the glasses for the colored member 24 be two-tone colored by blue and red to signify a bisexual common restroom. As shown in FIG. 4, a prismatic format is also applicable to the sign system 10 so that the replacement panel 12 can substantially prismatic in shape.

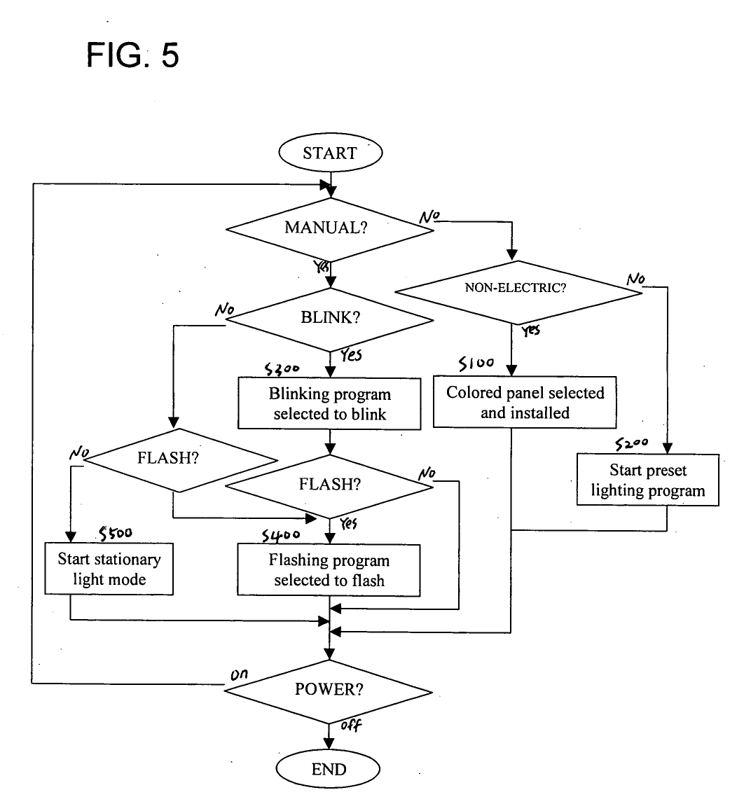

FIG. 5 is a flowchart showing how to control the controller 30 in a variety of control modes. As shown therein, when the controller 30 is not manually controlled and the sign system 10 is in an non-electric mode an appropriate panel is selected from the colored replacement panels 12A-12C (S100). Whereas, when the controller 30 is not manually controlled and the sign system 10 is not in an non-electric mode a preset lighting program automatically starts so that the bulbs 32 perform a preset combination of the bulb blinking and/or flashing (S200). For example, two bulbs 32 are linearly aligned on the circuit board 26, one bulb flashes whereas the other bulb blinks according to the preset program.

When the controller 30 is manually controlled to allow the blinking to begin then the user selects one of the blinking programs (S300). Meanwhile, if the blinking is deselected but flashing is selected the selected flashing is performed (S400). If neither of the blinking and the flashing is selected the controller 30 is set to start stationary light mode (S500) to maintain bulb lighting with neither blinking nor flashing. Also, the blinking function selected to perform one of the blinking programs (S300) may be immediately followed by the flashing function to simultaneously perform the flashing according to one of the flashing programs (S400) as long as electric power remains turned on.

As discussed above, an advantage of the present invention is that the color coded symbols provided in combination of colored plates 24 and non-colored bulbs 32, or the other combination of colored plates 24 and blinking and/or flashing bulbs 32 substantially improve recognition rate compared to the conventional symbols, thereby enhancing usability and applicability. In addition, the interchangeability of the replacement panels 12 allows flexibility and saves cost, thereby enhancing user satisfaction while decreasing maintenance cost. Further, the color allocation coded with ergonomic senses minimizes error ratio in finding the wanted spot, thereby maximizing product reliability.

While the present invention has been particularly shown and described with reference to the preferred embodiment thereof, it will be understood by those skilled in the art that various changes in form and details may be effected therein without departing from the spirit and scope of the invention as defined by the appended claims.

What is claimed is

1. A color coded sign system comprising:
a) a base frame mounted on a wall or a ceiling; and
b) a plurality of replacement panels each having at least one opening, wherein a selected one of the replacement panels is detachably hooked in hook rails of the base frame, wherein the opening is covered by a colored member.

2. The color coded sign system of claim 1 wherein the colored member selectively adopts blue, red, green, purple, brown and orange, wherein the blue, red, green, purple, brown and orange colored members sequentially signify a man's restroom sign, a lady's restroom sign, an exit/entrance sign, an elevator sign, a stairways sign and a no exit/entrance sign.

3. The color coded sign system of claim 1 wherein the colored member is an acrylic plate.

4. The color coded sign system of claim 1 wherein the colored member is formed of a glass.

5. A color coded sign system comprising:
a) a base frame mounted on a wall or a ceiling;
b) a circuit board having at least one electric port, wherein the circuit board is installed in the base frame and connected to a controller;
c) a light bulb having a bulb base, wherein the bulb base is detachably mounted in the port, wherein the light bulb is blinkable under control of the controller; and
d) a plurality of replacement panels each having at least one opening, wherein a selected one of the replacement panels is detachably hooked in hook rails of the base frame, wherein the opening is covered by a colored member.

6. The color coded sign system of claim 5 further comprising a flashing member removably provided between the bulb base and the port.

7. The color coded sign system of claim 6 wherein the flashing member is a bulb flasher.

8. The color coded sign system of claim 5 wherein the colored member is an acrylic plate.

9. The color coded sign system of claim 8 wherein the acrylic plate is colored by one selected from blue, red, green, purple, brown, and orange.

10. The color coded sign system of claim 9 wherein the blue, red, green, purple, brown and orange acrylic plates sequentially signify a man's restroom sign, a lady's restroom sign, an exit/entrance sign, an elevator sign, a stairways sign and a no exit/entrance sign.

11. The color coded sign system of claim 8 wherein the acrylic plate is two-tone colored by blue and red to signify a bisexual common restroom.

12. The color coded sign system of claim 5 wherein the colored member is formed of a glass.

13. The color coded sign system of claim 12 wherein the glass is colored by one selected from blue, red, green, purple, brown, and orange.

14. The color coded sign system of claim 13 wherein the blue, red, green, purple, brown and orange glasses sequentially signify a man's restroom sign, a lady's restroom sing, an exit/entrance sign, an elevator sign, a stairways sign and a no exit/entrance sign.

15. The color coded sign system of claim 12 wherein the glass is two-tone colored by blue and red to signify a bisexual common restroom.

16. A color coded sign system comprising:
a) a base frame mounted on a wall or a ceiling;
b) a circuit board having two or more electric ports, wherein the circuit board is installed in the base frame and connected to a controller;
c) light bulbs each having a bulb base, wherein the bulb base is detachably mounted in the port, wherein one of the light bulbs is blinkable under control of the controller;
d) a flashing member incorporated in the circuit board to control bulb blinking sequences and intervals; and
e) a plurality of replacement panels each having at least one opening, wherein a selected one of the replacement panels is detachably hooked in hook rails of the base frame, wherein the opening is covered by a colored member.

17. The color coded sign system of claim 16 wherein the flashing member is a bulb flasher.

18. The color coded sign system of claim 16 wherein the colored member is an acrylic plate.

19. The color coded sign system of claim 18 wherein the acrylic plate is colored by one selected from blue, red, green, purple, brown, and orange, wherein the blue, red, green, purple, brown and orange acrylic plates sequentially signify a man's restroom sign, a lady's restroom sign, an exit/entrance sign, an elevator sign, a stairways sign and a no exit/entrance sign.

20. The color coded sign system of claim 18 wherein the acrylic plate is two-tone colored by blue and red to signify a bisexual common restroom.

21. The color coded sign system of claim 16 wherein the colored member is formed of a glass.

22. The color coded sign system of claim 21 wherein the glass is colored by one selected from blue, red, green, purple, brown, and orange, wherein the blue, red, green, purple, brown and orange acrylic plates sequentially signify a man's restroom sign, a lady's restroom sign, an exit/entrance sign, an elevator sign, a stairways sign and a no exit/entrance sign.

23. The color coded sign system of claim 21 wherein the glass is two-tone colored by blue and red to signify a bisexual common restroom.

24. The color coded sign system of claim 16 wherein said each replacement panel is substantially prismatic in shape.
